(19) United States
(12) Patent Application Publication
(10) Pub. No.: US 2016/0295127 A1
(43) Pub. Date: Oct. 6, 2016

(54) Real-time image stitching apparatus and real-time image stitching method

(71) Applicant: ULTRACKER TECHNOLOGY CO., LTD., Taoyuan (TW)

(72) Inventor: MING-JUNG YU, Taoyuan (TW)

(21) Appl. No.: 14/967,516

(22) Filed: Dec. 14, 2015

(30) Foreign Application Priority Data
Apr. 2, 2015 (TW) 104110855

(51) Int. Cl. H04N 5/265; H04N 5/232

(52) U.S. Cl. CPC H04N 5/265; H04N 5/23238

(57) ABSTRACT

This invention discloses primarily using a digital chip in a platform rather than a central processing unit, driver or application software to stitch digital image signals from image sensors, and then transform it into an image file for output, display or storage. The stitched and compressed image is much smaller in the size of data computation to attend a real-time image stitching effect in a better quality and smoothness of image.

### BACKGROUND OF THE INVENTION

a) Field of the Invention

The present invention refers to the image stitching technology, and more particular to a real-time image stitching apparatus in a better quality and smoothness of image, as well as a related real-time image stitching method.

b) Description of the Prior Art

Since the release of a digital camera, the application and knowledge of electronic components grew sharply to create a lot of new experiences and devices of photography, both directly and indirectly. In the existing image capture devices, such as digital cameras or digital camcorders, CCD or CMOS sensors basically convert a light wave into stored charges and then image processors transform the digital information sent from the CCD or CMOS sensors into image files.

In principle, the image processor is responsible for performing analysis and all kinds of process to the data from the image sensors. It then transforms the data into image files according to the photographer's settings of quality and style, and saves them into a storage device, such as memory, flash card or hard disk.

In addition, the digital image capture devices may not be able to render the image widely enough to capture the entire scene required due to the technical limit of lens, in an actual operation. One way to get the entire scene required is to capture the parts of the scene separately and then stitch them together.

Image stitching finds physically the same feature points in any two pictures and rebuilds them into one picture by stitching. The traditional image stitching technology is usually done by post production, using computer software to stitch the related images loaded by computer software. This method requires a technology to operate the software, and spends relatively more time and work. Besides, it cannot get the real-time images in a large quantity and high resolution.

Furthermore, for the digital image application of an existing panorama camera, the real-time image stitching has already been achieved. However, the digital signals of image sensors are still encoded/decoded into an image file through the image processor, before stitiching the images by a CPU combined with a central processor. Therefore, in the process of stitching the images, the part of scene that is overlapped will be cut and deleted eventually, and each image after stitching will be corrected independently with auto exposure and auto white-balance, which results in an explicit difference in color among the stitched images instead.

Thus, for this kind of conventional image stitching technology, a lot of unused data will be included in the transmission and computation of each image. When the pixels of image and the data for analysis increase, the CPU will need to perform computation to the image files and store more data. In addition, each instruction has to be executed with more time. Therefore, a trade-off is made between the quality of image and the amount of image (number of sheets of image); this is why most conventional image stitching technology is provided with a shortcoming in low resolution or choppy video performance.

### SUMMARY OF THE INVENTION

To solve this issue, the present invention discloses an image stitching apparatus and a related real-time stitching method to provide images with a relatively better quality and higher frame rate.

To achieve the abovementioned object, the present invention discloses a real-time image stitching apparatus which includes at least one image sensor, and at least one digital chip connected electrically to each image sensor, wherein, the digital chip includes at least one algorithm-formed ISP (image signal processor), one algorithm-formed image stitcher, and one algorithm-formed image compressor.

In accordance with the technology described above, the said real-time image stitching apparatus includes a transmission medium electrically connected to the digital chip.

In accordance with the technology described above, the said real-time image stitching apparatus includes at least one storage device electrically connected to the digital chip.

In accordance with the technology described above, the said real-time image stitching apparatus includes a transmission medium and at least one storage device electrically connected to the digital chip.

In accordance with the technology described above, the storage device in the said real-time image stitching apparatus can be an SD card.

In accordance with the technology described above, the storage device in the said real-time image stitching apparatus can be an HDD.

In accordance with the technology described above, the transmission medium in the said real-time image stitching apparatus can be a network wire.

In accordance with the technology described above, the transmission medium in the said real-time image stitching apparatus can be a Wi-Fi device. In accordance with the technology described above, the transmission medium in the said real-time image stitching apparatus can be a USB device.

In accordance with the technology described above, the transmission medium in the said real-time image stitching apparatus can be an LTE device.

The said real-time image stitching apparatus includes multiple surround-set image sensors.

Each said image sensor is electrically connected to the digital chip through an image signal processor, respectively.

For the real-time image stitching method disclosed in the present invention, a digital chip is integrated into a digital image capture device. The digital chip includes at least one algorithm-formed image signal processor, one algorithm-formed image stitcher, and one algorithm-formed image compressor. The digital image signals from one or more image sensors of the digital image capture device are collected by the digital chip in a preset time period, the digital image signals collected in the preset time period are corrected by the image signal processor in the digital chip, the digital image signals collected in the preset time period are stitched by the image stitcher in the digital chip, and the stitched digital image signals stitched by the image compressor in the digital chip are then transformed into a preset image format for output or storage.

In accordance with the technology described above, the said real-time image stitching method processes auto exposure and auto white balance for the digital image signals collected in a preset time period by the image signal processor in the digital chip.

In accordance with the technology described above, the said real-time image stitching method processes optical correction to the digital image signals from each image sensor by the image signal processor connected electrically to each image sensor before being collected by the digital chip. The correction includes distortion fixing, noise reduction, and defective pixel fixing. Specifically, the real-time image stitching apparatus and the related real-time image stitching method disclosed in the present invention stitch images by a digital chip in a platform rather than a central processing unit (CPU), driver or application software, and then transform it into an image file for output, display or storage. The size of the computation data of the stitched and compressed image is relatively smaller, so that it can achieve a real-time image stitching effect in a better quality and higher frame rate of image to be widely applicable to a 360-degree panorama image in higher resolution for a real-time image surveillance system, or to a whole-scene or panorama photographing in higher resolution for a hand-held device, such as a digital camera or a smart phone.

### BRIEF DESCRIPTION OF THE DRAWINGS

FIG. 1 illustrates a block diagram of the basic structure of a first embodiment of the real-time image stitching apparatus, according to the present invention.

FIG. 2 illustrates a block diagram of the basic structure of a second embodiment of the real-time image stitching apparatus, according to the present invention.

FIG. 3 illustrates a schematic view of the layout of the image sensor, according to the present invention.

### DETAILED DESCRIPTION OF THE PREFERRED EMBODIMENTS

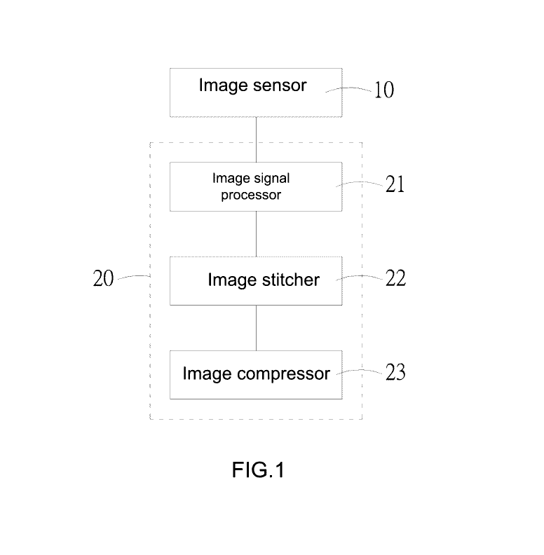

The present invention discloses primarily a real-time image stitching apparatus with a better quality of image and relatively smoother image, as well as a related real-time image stitching method. As illustrated in FIG. 1, it shows a block diagram of the basic structure of a first embodiment of the real-time image stitching apparatus, according to the present invention. The real-time image stitching apparatus in the present invention basically includes at least one image sensor (10) and a digital chip (20) connected electrically to each image sensor (10).

The digital chip (20) is built-in with at least one algorithm-formed mage signal processor (21), one algorithm-formed image stitcher (22), and one algorithm-formed image compressor (23).

Accordingly, the digital chip (20) collects digital image signals produced by the image sensor (10) in a preset time period, corrects auto white balance and auto exposure of the digital image signals by the built-in image signal processor (21), stitches the digital image signals by the built-in image stitcher (22), and then compresses the digital image signals by the built-in image compressor (23) into a preset image format for transmission or storage.

Because the entire real-time image stitching apparatus uses the digital chip (20) to stitch and compress the digital image signals from the image sensor (10) in a platform rather than a central processing unit, driver or application software, the size of the computation data of the stitched and compressed image file is relatively smaller, so that it can achieve a real-time image stitching effect in a better quality and higher frame rate of image to be widely applicable to a 360-degree panorama image in higher resolution for a real-time image surveillance system, or to a whole-scene or panorama photographing in higher resolution for a hand-held device, such as a digital camera or a smart phone.

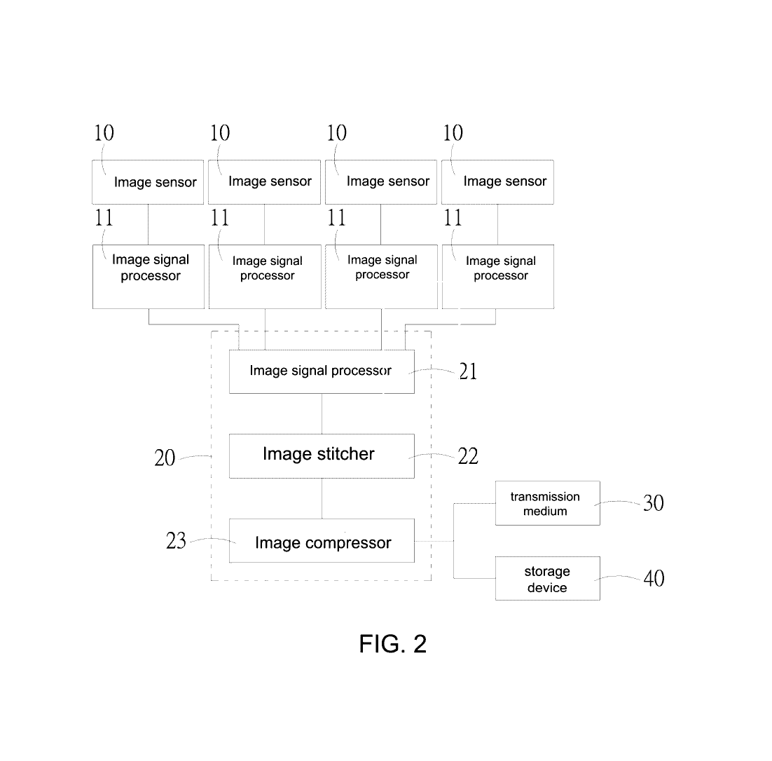

The real-time image stitching apparatus of the present invention, when in use, is illustrated in FIG. 2. The real-time image stitching apparatus further includes a transmission medium 30 electrically connected to the digital chip 20 to monitor in real-time the effect of the stitched images. Furthermore, it can also further include at least one storage device 40 connected electrically to the digital chip 20 to record the data of the stitched images.

Therefore, the real-time image stitching apparatus of the present invention, when in use, further includes preferably a transmission medium 30 and at least one storage device 40 connected electrically to the digital chip 20 to form a digital camera or smart phone with a whole-scene or panorama photographing ability in higher resolution, as shown in the drawings.

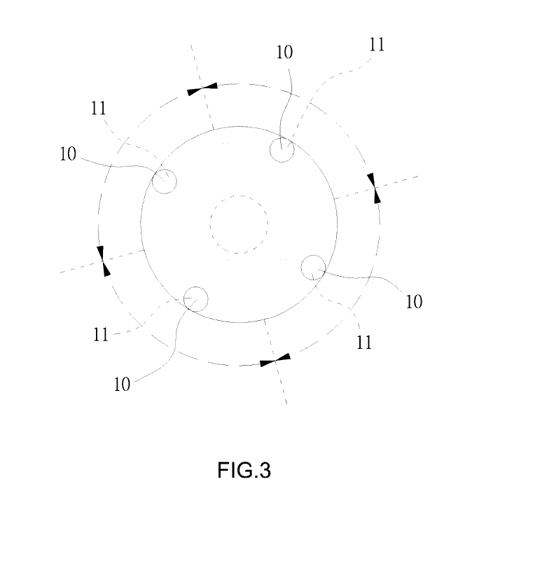

In addition, as illustrated in FIG. 3, the real-time image stitching apparatus of the present invention includes plural surrounding image sensors 10 to form a real-time image recorder which provides a 360-degree panorama image in higher resolution. In addition, under all kinds of possible implementation of the abovementioned structures, the said each image sensor 10 is connected electrically to the digital chip 20 through an image signal processor 11 respectively to process distortion fixing, noise reduction, and defective pixel fixing optically by the image signal processor 11 connected electrically to each image sensor 10, before inputting the digital image signal of each image sensor 10 to the digital chip 20.

Furthermore, in the image stitching method of the present invention, a digital chip is integrated into a digital image capture device. The digital chip includes at least an algorithm-formed image signal processor, an algorithm-formed image stitcher, and an algorithm-formed image compressor, integrating into a digital image capture device. The structure is illustrated in FIG. 1 or FIG. 2.

The real-time image stitching method of the present invention collects digital image signals from one or multiple image sensors of the digital image capture device in a preset time period by the digital chip, corrects digital image signals distortion collected in the preset time period by the image signal processor in the digital chip, stitches the digital image signals collected in the preset time period by the image stitcher in the digital chip, and then transforms the digital image signals stitched by the image compressor in the digital chip into a preset image format for output or storage.

Likewise, the real-time image stitching method disclosed in the present invention processes auto exposure and auto white balance for the digital image signals collected in a preset time period by the image signal processor in the digital chip. It also processes optical correction to the digital image signals from each image sensor by the image signal processor connected electrically to each image sensor before being collected by the digital chip. The correction includes distortion fixing, noise reduction, and defective pixel fixing.

Comparing to the traditional technology, the real-time image stitching apparatus disclosed in the present invention stitches collected digital image signals by a digital chip in a platform rather than a central processing unit (CPU), driver or application software, and then transforms it into an image file for output, display or storage. The size of the computation data of the stitched and compressed image is relatively smaller, so that it can achieve a real-time image stitching effect in a better quality and higher frame rate of image to be widely applicable to a 360-degree panorama image in higher resolution for a real-time image surveillance system, or to a whole-scene or panorama photographing in higher resolution for a hand-held device, such as a digital camera or a smart phone.

In accordance with the description above, the present invention discloses a better practical real-time image stitching apparatus and a related image stitching method.

What is claimed is:

1. A real-time image stitching apparatus comprising:
at least one image sensor, and at least one digital chip connected electrically to each image sensors, wherein the digital chip includes at least one algorithm-formed ISP (image signal processor), one algorithm-formed image stitcher, and one algorithm-formed image compressor.

2. The real-time image stitching apparatus according to claim 1, wherein the real-time image stitching apparatus further includes a transmission medium connected electrically to the digital chip.

3. The real-time image stitching apparatus according to claim 1, wherein the real-time image stitching apparatus further includes at least one storage device connected electrically to the digital chip.

4. The real-time image stitching apparatus according to claim 1, wherein the real-time image stitching apparatus further includes a transmission medium and at least one storage device connected electrically to the digital chip.

5. The real-time image stitching apparatus according to claim 4, wherein the storage device is an SD card.

6. The real-time image stitching apparatus according to claim 4, wherein the storage device is an HDD.

7. The real-time image stitching apparatus according to claim 4, wherein the transmission medium is a network wire.

8. The real-time image stitching apparatus according to claim 4, wherein the transmission medium is a Wi-Fi device.

9. The real-time image stitching apparatus according to claim 4, wherein the transmission medium is a USB device.

10. The real-time image stitching apparatus according to claim 4, wherein the transmission medium is an LTE device.

11. The real-time image stitching apparatus according to claim 1, wherein the real-time image stitching apparatus includes multiple surround-set image sensors.

12. The real-time image stitching apparatus according to claim 1, wherein each image sensor is connected electrically to the digital chip through an image signal processor.

13. A real-time image stitching method integrating a digital chip into a digital image capture device, with that the digital chip includes at least one algorithm-formed image signal processor, one algorithm-formed image stitcher, and one algorithm-formed image compressor; the digital chip collecting the digital image signals from one or more image sensors of the digital image capture device in a preset time period, correcting optically the digital image signals collected in the preset time period by the image signal processor in the digital chip, stitching the digital image signals collected in the preset time period by the image stitcher, and transforming the digital image signals stitched by the image compressor in the digital chip into a preset image format for output or storage.

14. The real-time image stitching method according to claim 13, wherein the real-time image stitching method processes auto exposure and auto white balance for the digital image signals collected in a preset time period by the image signal processor in the digital chip.

15. The real-time image stitching method according to claim 13, wherein the real-time image stitching method processes optical correction to the digital image signals from each image sensor by the image signal processor connected electrically to each image sensor before being collected by the digital chip, with that the correction includes distortion fixing, noise reduction, and defective pixel fixing.
